(19) United States
(12) Patent Application Publication
(10) Pub. No.: US 2026/0266710 A1
(43) Pub. Date: Sep. 10, 2026

(54) SCANNING RECOGNITION METHOD AND SCANNING RECOGNITION SYSTEM BASED ON GROUPED STRAIGHT-LINE GRATING

(71) Applicant: HUNAN TARGETING DETECTION TECHNOLOGY CO., LTD, Hunan (CN)

(72) Inventors: Chengkun XIE, Hunan (CN); Zhaohui LI, Hunan (CN); Feng HE, Hunan (CN); Xin HUANG, Hunan (CN); Lian TAO, Hunan (CN)

(73) Assignee: HUNAN TARGETING DETECTION TECHNOLOGY CO., LTD, Hunan (CN)

(21) Appl. No.: 18/721,197

(22) PCT Filed: Jun. 14, 2023
(86) PCT No.: PCT/CN2023/100180

§ 371 Date: Jun. 18, 2024

(30) Foreign Application Priority Data
Jun. 29, 2022 (CN) 202210748559.7

(51) Int. Cl. G01N 21/01; G01N 21/64; G01N 21/84

(52) U.S. Cl. CPC G01N 21/01; G01N 21/6402; G01N 21/84; G01N 2021/0106

(57) ABSTRACT

The present invention discloses a scanning recognition method based on a grouped straight-line grating, wherein the grouped straight-line grating is composed of a plurality of light collecting points arranged in groups in straight lines at intervals, and the light collecting points include light transmitting points or reflection points. Objects to be detected are spread evenly on a detection plate, and the detection plate is scanned by the relative movement between the grouped straight-line grating and the detection plate; light emitted or reflected by the objects to be detected is collected by the light collecting points and transmitted to a recognition device for photoelectric conversion, so as to realize scanning recognition of the detection plate. The grouped straight-line grating is used to dynamically and continuously count luminescent objects to be detected in order to reduce the recognition time, improve the detection efficiency, and improve the detection accuracy.

### TECHNICAL FIELD

The present invention relates to the technical field of detection, realizes digital single molecule scanning, and particularly relates to a scanning recognition method and scanning recognition system based on a grouped straight-line grating.

### BACKGROUND

Single molecule detection (SMD) is an ultra-sensitive detection technology developed rapidly in recent years, which means to determine and analyze a target object at single molecule level. SMD is a brand new detection method, and also opens up a brand new detection field. Single molecule fluorescence detection is the most commonly used method for single molecule detection, which reflects biological information about intermolecular interaction, enzyme activity, reaction kinetics, molecular conformation, DNA and RNA transcription, protein folding, etc. by marking changes of various characteristics of fluorophores on biological macromolecules. Single molecule fluorescence detection has a unique application value in chemical analysis, biological analysis, nanomaterial analysis, medical diagnosis, forensic analysis, single cell analysis, molecular dynamics mechanism investigation and other aspects, and has had and is having a profound impact on the development of many disciplines. Single molecule fluorescence detection can be divided into three types: photon burst detection, single molecule image recording and single molecule spectral mapping. Photon burst detection is the simplest, which is to directly measure the number of burst photons. Single molecule imaging can indicate the position and luminescent intensity of molecules in an image, and track and record single molecules in real time. Among which, Simoa (Single-molecule Array) technology developed by American Quanterix is the most advanced single molecule fluorescence detection technology at present. Simoa technology has a sensitivity of more than 1000 times that of ELISA technology and a lower detection limit of fg/mL, which realizes effective detection and quantification of single molecules.

However, the existing Simoa technology is to count the number of luminescent analytes in a picture after imaging, which has a high requirement for imaging equipment and a low detection speed, resulting in difficult application and promotion of Simoa technology. For this reason, the present application is to use a grouped straight-line grating to dynamically and continuously count luminescent objects to be detected, so as to achieve digital single molecule scanning, and thereby improving the detection accuracy, reducing the recognition time and improving the detection efficiency.

According to patent search, the following patents are mainly related to the present application:

Chinese invention patent with application No. “202110018302.1”, application date “2021.01.07”, publication No. “CN112859256A”, publication date “2021.05.28”, title “a grating coupler positioning and measurement method based on image recognition” and applicant “Tianjin University”. The patent for invention discloses a grating coupler positioning and measurement method based on image recognition, which specifically comprises the following steps: (1) positioning position coordinates of a grating coupler in a chip design drawing; (2) mapping and matching the size of a chip on the chip design drawing with that on a measuring platform to obtain the position coordinates of the grating coupler in the chip; (3) using a program to control the movement of a displacement table, thus to realize micrometer-level positioning of coupled optical fibers and the grating coupler; (4) using a spatial scanning method to realize positioning of the coupled optical fibers and the grating coupler below a 100 nm level, and finding an optimal coupling position to conduct chip measurement. However, the patent is to scan optical signals on the grating coupler point by point by moving the optical fibers, which has a low detection efficiency.

Chinese invention patent with application No. “202111571233.3”, application date “2021.12.21”, publication No. “CN114240755A”, publication date “2022.03.25”, title “an image super-resolution reconstruction method based on fiber bundle combined with microscanning technology” and applicant “Institute of Optics and Electronics, Chinese Academy of Sciences”. The patent for invention discloses an image super-resolution reconstruction method based on fiber bundle combined with microscanning technology, which comprises a collimating lens, a fiber bundle, a displacement driver, a photodetector, a high-voltage amplifier, a displacement control device and a data acquisition device. An object is imaged by the collimating lens in an image space focal plane thereof and received by the fiber bundle, and a voltage signal is generated by the displacement control device, amplified by the high-voltage amplifier and exerted on the displacement driver, so that a fiber bundle area array can carry out micro-displacement scanning on an image formed by a target object, and precisely adjust the scan step size of a system to realize a displacement less than or equal to a diffraction limit of an optical system. The present invention uses the image transmission characteristics of a fiber bundle core in combination with microscanning technology to break the limitation of target detection and recognition affected by the pixel size of the photodetector, realize sub-pixel displacement, and compensate the missed information of a cladding; and uses a photodetector array to quickly capture the light energy information at an output end of the fiber bundle, reduce information loss, and realize ultra-high resolution imaging with a large field of view. However, the patent is to project optical signals onto the fiber bundle through a convex lens imaging method, rather than using a scanning method to detect the optical signals, which has a low detection accuracy.

Chinese invention patent with application No. “200810201668.7”, application date “2008.10.23”, publication No. “CN101387527B”, publication date “2010.12.15”, title “a fiber grating sensing demodulator and an application thereof” and applicant “Cao Chungeng”. The patent for invention relates to a fiber grating sensing demodulator; the demodulator comprises a high power ASE wide spectrum light source, a low light level mechanical scanning filter system, an optical coupler, a photodetector, a logarithmic amplification circuit, a signal acquisition, amplification and analog-to-digital conversion circuit, and a digital signal processing system; the high power ASE wide spectrum light source is connected with the low light level mechanical scanning filter system, the low light level mechanical scanning filter system is connected with the optical coupler, the optical coupler is connected with the photodetector, and the photodetector is connected with the logarithmic amplification circuit, the signal acquisition, amplification and analog-to-digital conversion circuit, and the digital signal processing system in sequence. The accuracy of the present invention has been greatly improved, and the demodulator is based on a low light level mechanical scanning filter technology and a DSP signal acquisition and processing technology, which has a stable and reliable performance and a high measurement accuracy; a center reflection wavelength of a fiber Bragg grating can be read remotely to realize remote real-time reading of the demodulator, and the engineering implementation for a network layout of a sensing system is simple and easy. However, the patent is to conduct detection by a fiber Bragg grating sensor, which is different from the scanning recognition method of adopting a grouped straight-line grating in the present application.

### SUMMARY

A technical problem to be solved in the present invention is to overcome the defects in the prior art, and provide a scanning recognition method and scanning recognition system based on a grouped straight-line grating.

To solve the above technical problems, the present invention adopts the technical solution: a scanning recognition method based on a grouped straight-line grating, wherein the grouped straight-line grating is composed of a plurality of light collecting points arranged in groups in straight lines at intervals, and the light collecting points include light transmitting points or reflection points. Objects to be detected are spread evenly on a detection plate, and the detection plate is scanned by the relative movement between the grouped straight-line grating and the detection plate; light emitted or reflected by the objects to be detected is collected by the light collecting points and transmitted to a recognition device for photoelectric conversion, so as to realize scanning recognition of the detection plate. The grouped straight-line grating is used to dynamically and continuously count luminescent objects to be detected in order to reduce the recognition time, improve the detection efficiency, and improve the detection accuracy. The light collecting points are square, circular or oval.

Further, the objects to be detected are spread evenly on the detection plate in the form of a matrix, the spacing of adjacent light collecting points of the grouped straight-line grating is the same as the spacing of the matrix of the objects to be detected. Therefore, the light collecting points can be aligned with the objects to be detected to reduce the interference caused when the light collecting points cannot be aligned with the objects to be detected, and can greatly improve the scanning recognition accuracy.

Further, a plurality of light collecting points are arranged at intervals along a grating direction X to compose the grouped straight-line grating. The light collecting points in the grouped straight-line grating are corresponding to a row of objects to be detected in the matrix on the detection plate. During relative movement between the grouped straight-line grating and the detection plate, each row of objects to be detected in the matrix on the detection plate are scanned by the grouped straight-line grating in sequence.

Further, adjacent light collecting points are arranged in a stagger layout in a direction perpendicular to the grating direction. The light collecting points in the grouped straight-line grating are corresponding to two adjacent rows of objects to be detected in the matrix on the detection plate, so as to increase the distance between adjacent light collecting points, reduce or avoid light interference of the objects to be detected adjacent to the objects to be detected aligned with the light collecting points, and improve the detection accuracy.

Further, the staggered distance between adjacent light collecting points is equal to the spacing of adjacent light collecting points. The spacing is the same as the spacing of the matrix of the objects to be detected, so that the light collecting points arranged in a stagger layout of the grouped straight-line grating are corresponding to the positions of the objects to be detected.

Further, the direction of relative movement between the grouped straight-line grating and the detection plate is perpendicular to the grating direction.

Further, light emitted or reflected by the objects to be detected is collected by the grouped straight-line grating and transmitted to the recognition device through optical fibers. The grouped straight-line grating is arranged on one end of each of the optical fibers, and the recognition device is arranged on the other end of each of the optical fibers. Optical signals are transmitted by the optical fibers, so that the position of the recognition device can be flexibly arranged, which makes the structure of a scanning recognition system more compact.

Further, one end of each of a plurality of optical fibers is arranged at intervals along the grating direction X to form the light collecting points arranged in groups in straight lines at intervals, so as to form a multi-fiber straight-line grating or a multi-fiber staggered grating. One end of each of the plurality of optical fibers is used as a light collecting point, which can simplify the structure of the scanning recognition system and reduce the cost.

Further, the end surface of one end of each single optical fiber is processed by photolithography, erosion or plating to form the light collecting points arranged in groups in straight lines at intervals, so as to form a single-fiber straight-line grating or a single-fiber staggered grating. One end of each single optical fiber is used to prepare the grouped straight-line grating, so as to reduce the number of optical fibers and further reduce the cost.

The present invention also relates to a scanning recognition system implementing the scanning recognition method, which comprises the detection plate and an excitation light source, and the detection plate is irradiated by the excitation light source. The scanning recognition system also comprises the grouped straight-line grating, the optical fibers, a moving device and the recognition device; the grouped straight-line grating is arranged on one end of each of the optical fibers, the recognition device is arranged on the other end of each of the optical fibers, and the detection plate or the grouped straight-line grating is driven by the moving device to move, so as to achieve the relative movement between the grouped straight-line grating and the detection plate; the detection plate is scanned by the grouped straight-line grating, optical signals obtained by scanning are transmitted to the recognition device through the optical fibers and converted into electrical signals by the recognition device, so as to achieve scanning recognition of the detection plate. The grouped straight-line grating is used to dynamically and continuously count luminescent objects to be detected in order to reduce the recognition time, improve the detection efficiency, and improve the detection accuracy.

The present invention has the following beneficial effects: luminescent objects to be detected are dynamically and continuously counted by the grouped straight-line grating in order to reduce the recognition time, improve the detection efficiency, and improve the detection accuracy. At the same time, the grouped straight-line grating is prepared by the optical fibers, which can simplify the structure of the scanning recognition system and reduce the cost.

### DESCRIPTION OF DRAWINGS

FIG. 1 is a three-dimensional structural schematic diagram of embodiment 1 of a scanning recognition system,

FIG. 2 is a front view of embodiment 1 of a scanning recognition system,

FIG. 3 is a three-dimensional structural schematic diagram of embodiment 2 of a scanning recognition system,

FIG. 4 is a front view of embodiment 2 of a scanning recognition system,

FIG. 5 is a schematic diagram of a detection plate,

FIG. 6 is a three-dimensional structural schematic diagram of a single-fiber straight-line grating of embodiment 1 of a grouped straight-line grating,

FIG. 7 is a three-dimensional structural schematic diagram of a single-fiber staggered grating of embodiment 2 of a grouped straight-line grating,

FIG. 8 is a three-dimensional structural schematic diagram of a multi-fiber straight-line grating of embodiment 3 of a grouped straight-line grating,

FIG. 9 is a front view of a multi-fiber straight-line grating of embodiment 3 of a grouped straight-line grating,

FIG. 10 is a three-dimensional structural schematic diagram of a multi-fiber staggered grating of embodiment 4 of a grouped straight-line grating,

FIG. 11 is a front view of a multi-fiber staggered grating of embodiment 4 of a grouped straight-line grating,

FIG. 12 is a schematic diagram of a scanning recognition process 1,

FIG. 13 is a schematic diagram of a scanning recognition process 2,

FIG. 14 is a schematic diagram of a scanning recognition process 3, and

FIG. 15 is a schematic diagram of a scanning recognition process 4.

In the figures: 1—moving device, 2—detection plate, 3—excitation light source, 4—grouped straight-line grating, 41—multi-fiber straight-line grating, 42—multi-fiber staggered grating, 43—single-fiber straight-line grating, 44—single-fiber staggered grating, 401—light collecting point, 5—optical fiber, 6—recognition device, d—maximum size of objects to be detected, K—spacing of matrix of objects to be detected, L—spacing of adjacent light collecting points, M—staggered distance between adjacent light collecting points, P—maximum size of light collecting points, Q—diameter of optical fibers, X—grating direction, and Y—detection plate moving direction.

### DETAILED DESCRIPTION

The present invention is further described below through specific embodiments in combination with drawings.

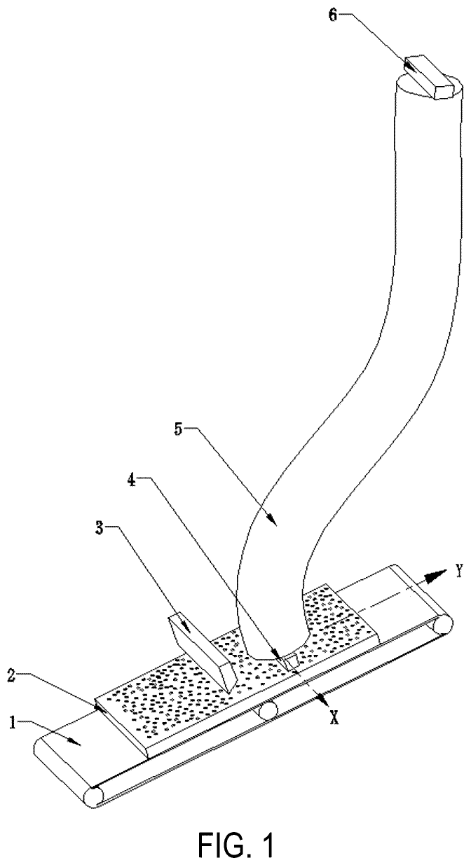

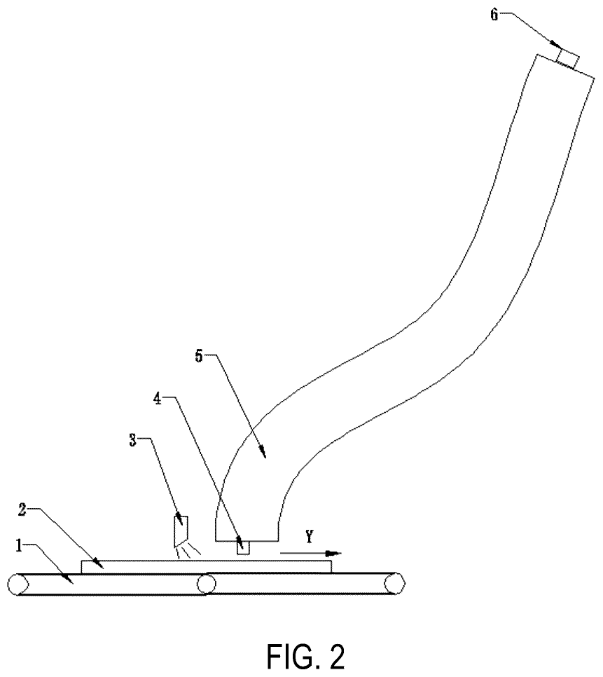

Embodiment 1 of a scanning recognition system of the present application is shown in FIG. 1 and FIG. 2, which comprises a moving device 1, a detection plate 2, an excitation light source 3, a grouped straight-line grating 4, optical fibers 5 and a recognition device 6.

Objects to be detected 201 are diluted in solution and then scattered evenly on the detection plate 2 or a detection tape. The grouped straight-line grating 4 is composed of a plurality of light collecting points 401 arranged at intervals along a grating direction X. The light collecting points 401 are square, circular or oval.

The excitation light source 3 and the grouped straight-line grating 4 are arranged on the same side of the detection plate 2. The detection plate 2 is arranged on the moving device 1, and the grouped straight-line grating 4 can also be arranged on the moving device 1, so that relative movement is formed between the detection plate 2 or the detection tape and the grouped straight-line grating 4. The detection plate 2 is irradiated by light emitted by the excitation light source 3 to excite part of the objects to be detected 201 bound with a fluorescent marker to emit light. When the light collecting points 401 are close to and aligned with the objects to be detected 201, optical signals emitted by the objects to be detected 201 are collected and transmitted to the recognition device 6 through the optical fibers 5, and the optical signals collected by the grouped straight-line grating 4 are converted into electrical signals by a photosensitive tube in the recognition device 6 for calculation or remote transmission display.

In order to simplify the structure of detection components, the grouped straight-line grating 4 can be combined with one end of each of the optical fibers 5. One end of each of a plurality of optical fibers 5 can be arranged in groups in straight lines at intervals to form light collecting points 401 arranged in groups in straight lines at intervals, so as to form a multi-fiber straight-line grating 41 or a multi-fiber staggered grating 42; diameter Q of the optical fibers shall be within a range of 0.5-1.5 times the maximum size d of the objects to be detected. The end surface of one end of each single optical fiber 5 can also be processed by photolithography, erosion or plating to form the light collecting points 401 arranged in groups in straight lines at intervals, so as to form a single-fiber straight-line grating 43 or a single-fiber staggered grating 44; the maximum size P of the light collecting points shall be within a range of 0.5-1.5 times the maximum size d of the objects to be detected.

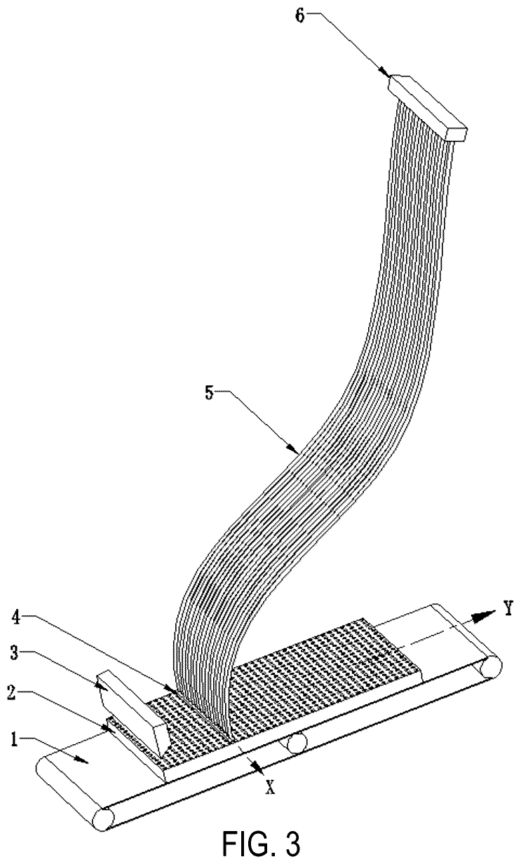

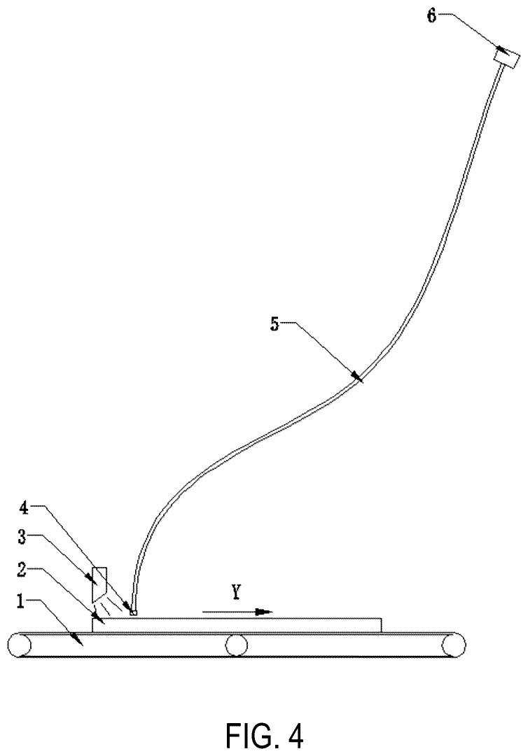

Embodiment 2 of a scanning recognition system of the present application is shown in FIG. 3 and FIG. 4, which comprises a moving device 1, a detection plate 2, an excitation light source 3, a grouped straight-line grating 4, optical fibers 5 and a recognition device 6.

In order to enable the light collecting points 401 to be aligned with the objects to be detected 201 to reduce the interference caused when the light collecting points 401 cannot be aligned with the objects to be detected 201, and improve scanning recognition accuracy, the objects to be detected 201 are arranged on the detection plate 2 or the detection tape in the form of a matrix. The number of light collecting points 401 of the grouped straight-line grating 4 is greater than or equal to the number of columns in the matrix of the objects to be detected 201 on the detection plate 2, so that each object to be detected 201 in each row is corresponding to one light collecting point 401. The maximum size of the light collecting points 401 shall be within a range of 0.5-1.5 times the maximum size d of the objects to be detected, so as to make the size of the light collecting points 401 equivalent to the size of the objects to be detected 201. When the light collecting points 401 are close to and aligned with the objects to be detected 201, it is ensured that the optical signals collected by the light collecting points 401 are the optical signals emitted by the aligned objects to be detected 201, so as avoid interference of optical signals emitted by the objects to be detected 201 around, and improve the scanning recognition accuracy and the detection accuracy. Therefore, the grouped straight-line grating 4 cannot be a strip grating, but a square, circular or oval grating, so as to prevent the light emitted by the objects to be detected 201 around the objects to be detected 201 aligned with the light collecting points 401 from entering the light collecting points 401 and interfering with the detection accuracy.

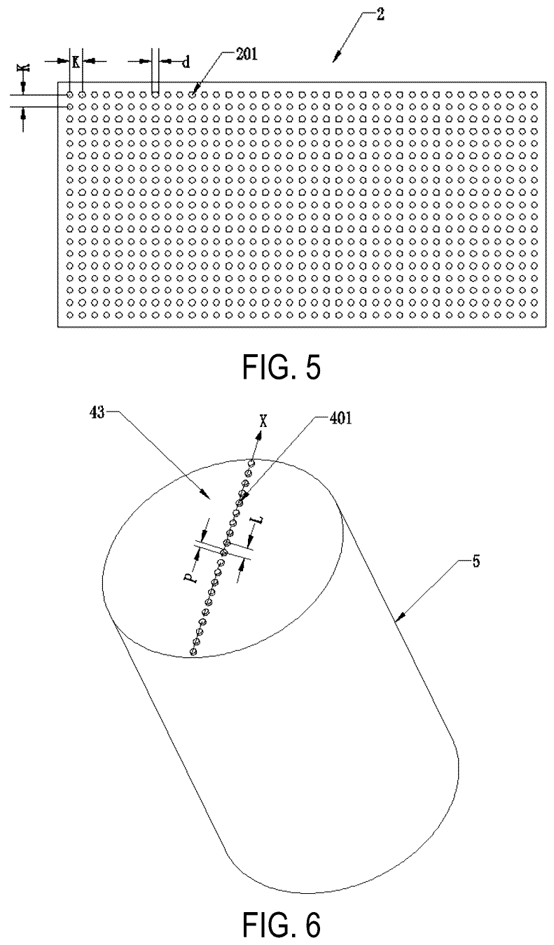

The detection plate 2 or the detection tape is shown in FIG. 5, in which the objects to be detected 201 are arranged on the detection plate 2 in the form of a matrix, and the spacing of the matrix of the objects to be detected 201 is K. The objects to be detected 201 comprise molecules of various analytes to be detected in chemical analysis, protein analysis, nucleic acid analysis, cell analysis, exosome analysis, circulating tumor cell analysis, nanomaterial analysis, etc., and can be used in the fields of precision medicine, medicolegal expertise, food safety and environmental protection. Part of the objects to be detected 201 are bound with a fluorescent marker, and the fluorescent marker on the objects to be detected 201 will be excited to emit fluorescence after the objects to be detected 201 are irradiated by the light emitted by the excitation light source 3.

The single-fiber straight-line grating of embodiment 1 of the grouped straight-line grating is shown in FIG. 6, in which the grouped straight-line grating 4 adopts the single-fiber straight-line grating 43, that is, one end of each single optical fiber 5 is processed by photolithography, erosion or plating to form the light collecting points 401 arranged in straight lines at intervals along the grating direction X, and the spacing L of adjacent light collecting points is the same as the spacing K of the matrix of the objects to be detected or 12 times the spacing K of the matrix of the objects to be detected.

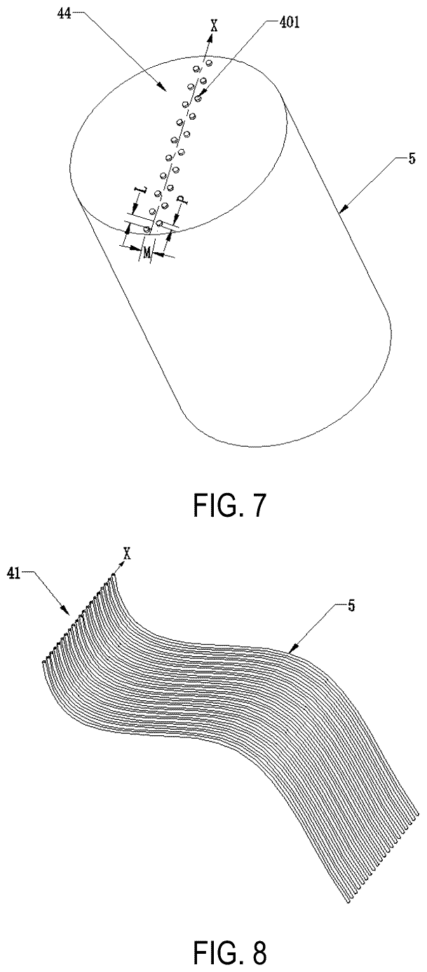

The single-fiber staggered grating of embodiment 2 of the grouped straight-line grating is shown in FIG. 7, in which the grouped straight-line grating 4 adopts the single-fiber staggered grating 44, that is, one end of each single optical fiber 5 is processed by photolithography, erosion or plating to form the light collecting points 401 arranged in a stagger layout at intervals along the grating direction X. The spacing L of adjacent light collecting points is the same as the spacing K of the matrix of the objects to be detected, and the staggered distance M between adjacent light collecting points is the same as the spacing K of the matrix of the objects to be detected or an integer multiple of the spacing K of the matrix of the objects to be detected. The light collecting points 401 of the single-fiber staggered grating 44 are corresponding to two rows of objects to be detected 201 on the detection plate 2.

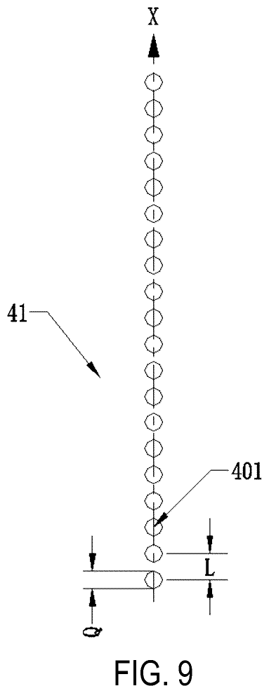

The multi-fiber straight-line grating of embodiment 3 of the grouped straight-line grating is shown in FIG. 8 and FIG. 9, in which the grouped straight-line grating 4 adopts the multi-fiber straight-line grating 41, that is, one end of each of the optical fibers 5 is used as a light collecting point 401, and one end of each of the plurality of optical fibers 5 is arranged in straight lines at intervals along the grating direction X with the spacing L. The spacing L of adjacent light collecting points is the same as the spacing K of the matrix of the objects to be detected or 12 times the spacing K of the matrix of the objects to be detected. The fluorescence on the objects to be detected 201 is collected by one end of each of the optical fibers 5, transmitted through the optical fibers 5 to the other end of each of the optical fibers 5, and converted into electrical signals by the photosensitive tube in the recognition device 6.

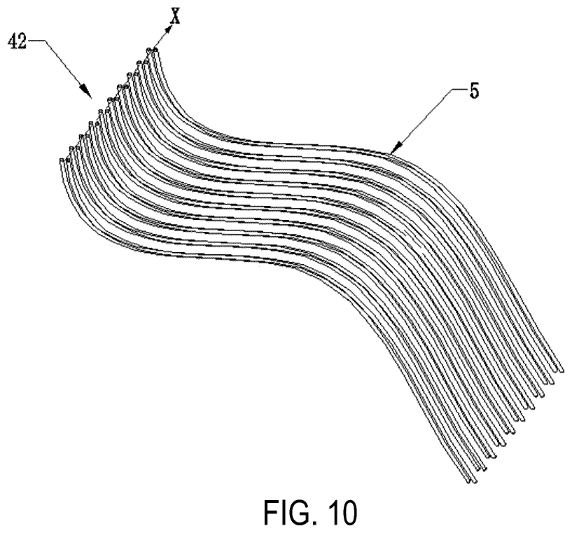

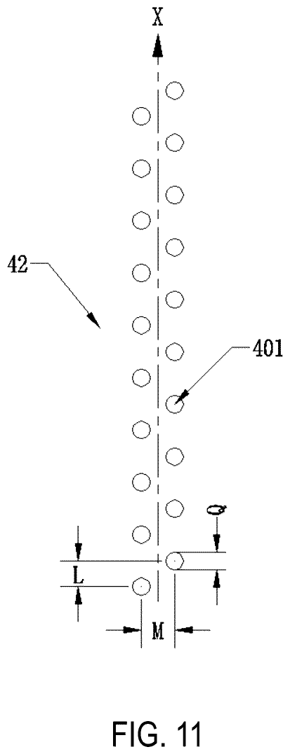

The multi-fiber staggered grating of embodiment 4 of the grouped straight-line grating is shown in FIG. 10 and FIG. 11, in which the grouped straight-line grating 4 adopts the multi-fiber staggered grating 42, that is, one end of each of the plurality of optical fibers 5 is arranged at intervals along the grating direction X, and at the same time, one end of each of adjacent fibers 5 is arranged in a stagger layout in a direction perpendicular to the grating direction X. The spacing L of adjacent light collecting points is the same as the spacing K of the matrix of the objects to be detected, and the staggered distance M between adjacent light collecting points is the same as the spacing K of the matrix of the objects to be detected or an integer multiple of the spacing K of the matrix of the objects to be detected. One end of each of the optical fibers 5 of the multi-fiber staggered grating 42 is, that is, the light collecting points 401 of the multi-fiber staggered grating 42 are corresponding to the two rows of objects to be detected 201 on the detection plate 2. The stagger layout can increase the distance between adjacent light collecting points 401, so as to reduce or avoid light interference of the objects to be detected 201 adjacent to the objects to be detected 201 aligned with the light collecting points 401, and improve the detection accuracy.

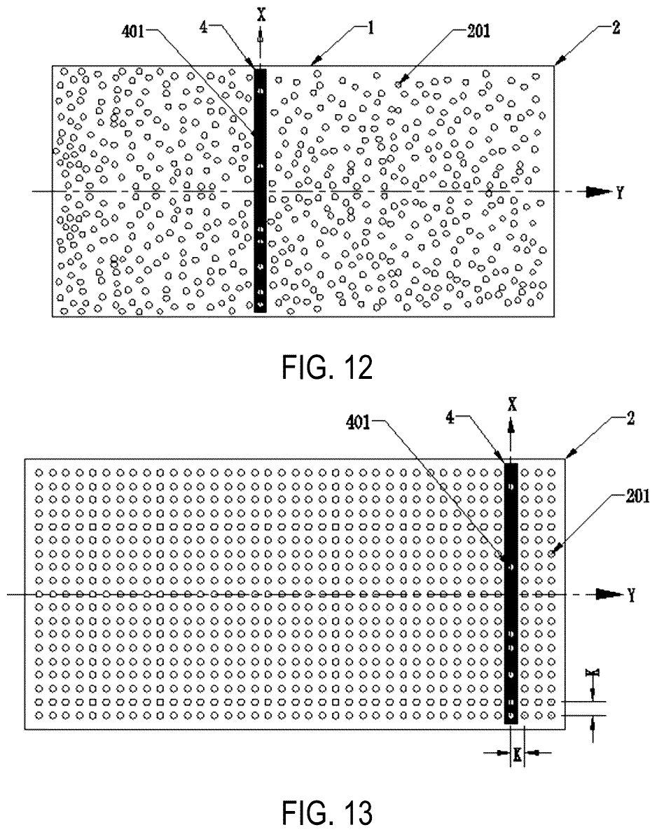

A scanning recognition process 1 of the scanning recognition method based on the grouped straight-line grating of the present application is shown in FIG. 12, in which the objects to be detected 201 are diluted in solution and then scattered evenly on the detection plate 2. The detection plate 2 is driven by the moving device 1 to move relatively to the grouped straight-line grating 4. At the same time, the detection plate 2 or the detection tape is irradiated by the light emitted by the excitation light source 3 to excite part of the objects to be detected 201 bound with a fluorescent marker to emit light. The objects to be detected 201 spread evenly on the detection plate 2 are scanned by the light collecting points 401 on the multi-fiber straight-line grating 41 or the single-fiber straight-line grating 43, optical signals emitted by the objects to be detected 201 are collected by the light collecting points 401 and transmitted to the recognition device 6 through the optical fibers 5, and the optical signals collected by the grouped straight-line grating 4 are converted into electrical signals by the photosensitive tube in the recognition device 6 for counting.

A scanning recognition process 2 of the scanning recognition method based on the grouped straight-line grating of the present application is shown in FIG. 13, in which the detection plate 2 is driven by the moving device 1 to move relatively to the grouped straight-line grating 4. The light collecting points 401 on the multi-fiber straight-line grating 41 or the single-fiber straight-line grating 43 are corresponding to the positions of the objects to be detected 201 scattered on the detection plate 2 in the form of a matrix. At the same time, the detection plate 2 is irradiated by the light emitted by the excitation light source 3 to excite part of the objects to be detected 201 bound with a fluorescent marker to emit light. When the light collecting points 401 are aligned with the objects to be detected 201 in a first row, optical signals emitted by the luminescent objects to be detected 201 in the first row will be collected and transmitted to the recognition device 6 through the optical fibers 5, and the optical signals collected by the grouped straight-line grating 4 are converted into electrical signals by the photosensitive tube in the recognition device 6 for counting. During the relative movement between the detection plate 2 and the grouped straight-line grating 4, the optical signals emitted by each row of objects to be detected 201 on the detection plate 2 are collected in sequence by the light collecting points 401 on the multi-fiber straight-line grating 41 or the single-fiber straight-line grating 43 to calculate the number of luminescent objects to be detected 201 on the detection plate 2, so as to realize dynamic and continuous counting of the objects to be detected 201, thereby improving the detection accuracy, reduce the identification time and improve the detection efficiency.

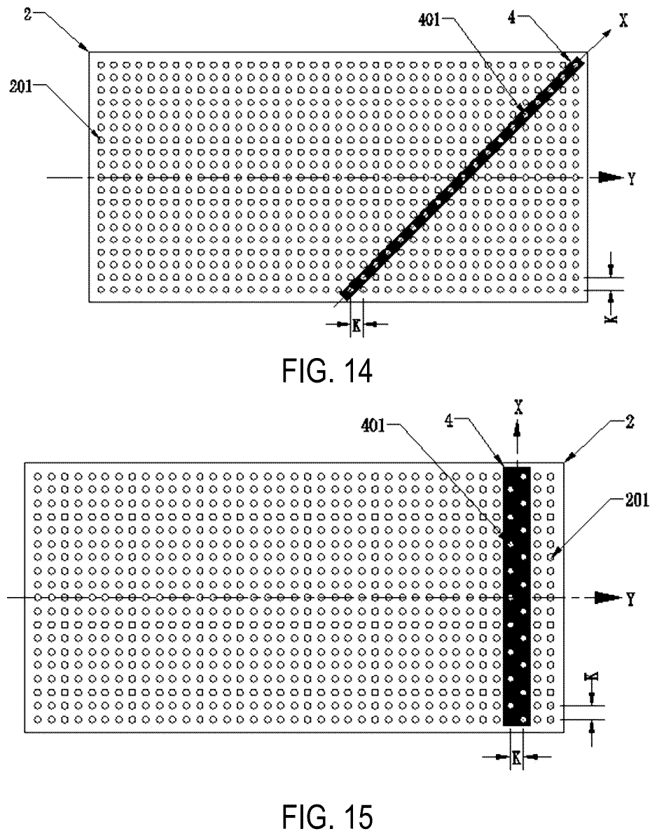

A scanning recognition process 3 of the scanning recognition method based on the grouped straight-line grating of the present application is shown in FIG. 14, in which the grating direction X is at an oblique angle of 45° to the detection plate moving direction Y. At this time, the spacing L of adjacent light collecting points is 12 times the spacing K of the matrix of the objects to be detected, so that each light collecting point 401 on the multi-fiber straight-line grating 41 or the single-fiber straight-line grating 43 is corresponding to each object to be detected 201 at a 45° direction in the matrix of the objects to be detected 201 on the detection plate 2, respectively. During the relative movement between the detection plate 2 and the grouped straight-line grating 4, the optical signals emitted by each column of objects to be detected 201 on the detection plate 2 are collected in sequence by the light collecting points 401 on the multi-fiber straight-line grating 41 or the single-fiber straight-line grating 43 to calculate the number of luminescent objects to be detected 201 on the detection plate 2, so as to realize dynamic and continuous counting of the objects to be detected 201. The detection method can increase the distance between adjacent light collecting points 401, reduce or avoid light interference of the objects to be detected 201 adjacent to the objects to be detected 201 aligned with the light collecting points 401, and improve the detection accuracy.

A scanning recognition process 4 of the scanning recognition method based on the grouped straight-line grating of the present application is shown in FIG. 15, in which the grouped straight-line grating 4 adopts the multi-fiber staggered grating 42 or the single-fiber staggered grating 44. The light collecting points 401 on the multi-fiber staggered grating 42 or the single-fiber staggered grating 44 are corresponding to the positions of two rows of objects to be detected 201 scattered on the detection plate 2 in the form of a matrix. When the light collecting points 401 at front positions are aligned with half of the objects to be detected 201 in a first row by skipping, optical signals emitted by half of the objects to be detected 201 in the first row will be collected and transmitted to the recognition device 6 through the optical fibers 5; when the light collecting points 401 at front positions are aligned with half of the objects to be detected 201 in a second row, the light collecting points 401 at rear positions will be aligned with the rest half of the objects to be detected 201 in the first row that are not scanned. During the relative movement between the detection plate 2 and the grouped straight-line grating 4, the optical signals emitted by each row of objects to be detected 201 on the detection plate 2 can be collected in sequence by the light collecting points 401 on the multi-fiber staggered grating 42 or the single-fiber staggered grating 44 to calculate the number of luminescent objects to be detected 201 on the detection plate 2, so as to realize dynamic and continuous counting of the objects to be detected 201. The light collecting points 401 in the multi-fiber staggered grating 42 or the single-fiber staggered grating 44 are corresponding to two adjacent rows of objects to be detected 201 in the matrix on the detection plate 2, so as to increase the distance between adjacent light collecting points 401, reduce or avoid light interference of the objects to be detected 201 adjacent to the objects to be detected 201 aligned with the light collecting points 401, and improve the detection accuracy.

To sum up, the present invention has the following beneficial effects: luminescent objects to be detected are dynamically and continuously counted by the grouped straight-line grating in order to reduce the recognition time, improve the detection efficiency, and improve the detection accuracy. At the same time, the grouped straight-line grating is prepared by the optical fibers, which can simplify the structure of the scanning recognition system and reduce the cost.

The above embodiments are merely used for illustration of the present invention, and are not intended to limit the present invention. Various changes or transformations can also be made by those skilled in the art without departing from the spirit and the scope of the present invention. Therefore, all equivalent technical solutions shall also belong to the protection scope of the present invention, and the protection scope of the present invention shall be defined by the claims.

1. A scanning recognition method based on a grouped straight-line grating, wherein the grouped straight-line grating is composed of a plurality of light collecting points arranged in groups in straight lines at intervals, and the light collecting points include light transmitting points or reflection points;
wherein objects to be detected are spread evenly on a detection plate, and the detection plate is scanned by the relative movement between the grouped straight-line grating and the detection plate; light emitted or reflected by the objects to be detected is collected by the light collecting points and transmitted to a recognition device for photoelectric conversion, so as to realize scanning recognition of the detection plate.

2. The scanning recognition method based on a grouped straight-line grating according to claim 1, wherein the objects to be detected are spread evenly on the detection plate in the form of a matrix, a spacing of adjacent light collecting points of the grouped straight-line grating is the same as a spacing of the matrix of the objects to be detected.

3. The scanning recognition method based on a grouped straight-line grating according to claim 2, wherein a plurality of light collecting points are arranged at intervals along a grating direction to compose the grouped straight-line grating.

4. The scanning recognition method based on a grouped straight-line grating according to claim 3, wherein adjacent light collecting points are arranged in a stagger layout in a direction perpendicular to the grating direction.

5. The scanning recognition method based on a grouped straight-line grating according to claim 4, wherein a staggered distance between adjacent light collecting points is equal to the spacing of adjacent light collecting points.

6. The scanning recognition method based on a grouped straight-line grating according to claim 1, wherein the direction of relative movement between the grouped straight-line grating and the detection plate is perpendicular to the grating direction.

7. The scanning recognition method based on a grouped straight-line grating according to claim 6, wherein light emitted or reflected by the objects to be detected is collected by the grouped straight-line grating and transmitted to the recognition device through optical fibers; the grouped straight-line grating is arranged on one end of each of the optical fibers, and the recognition device is arranged on the other end of each of the optical fibers.

8. The scanning recognition method based on a grouped straight-line grating according to claim 7, wherein one end of each of a plurality of optical fibers is arranged at intervals along the grating direction to form the light collecting points arranged in groups in straight lines at intervals, so as to form a multi-fiber straight-line grating or a multi-fiber staggered grating.

9. The scanning recognition method based on a grouped straight-line grating according to claim 7, wherein the end surface of one end of each single optical fiber is processed by photolithography, erosion or plating to form the light collecting points arranged in groups in straight lines at intervals, so as to form a single-fiber straight-line grating or a single-fiber staggered grating.

10. A scanning recognition system according to the scanning recognition method of claim 1, which comprises the detection plate and an excitation light source, and the detection plate is irradiated by the excitation light source; wherein the scanning recognition system further comprises the grouped straight-line grating, the optical fibers, a moving device and the recognition device; the grouped straight-line grating is arranged on one end of each of the optical fibers, the recognition device is arranged on the other end of each of the optical fibers, and the detection plate or the grouped straight-line grating is driven by the moving device to move, so as to achieve the relative movement between the grouped straight-line grating and the detection plate; the detection plate is scanned by the grouped straight-line grating, optical signals obtained by scanning are transmitted to the recognition device through the optical fibers and converted into electrical signals by the recognition device, so as to achieve scanning recognition of the detection plate.

11. The scanning recognition method based on a grouped straight-line grating according to claim 2, wherein the direction of relative movement between the grouped straight-line grating and the detection plate is perpendicular to the grating direction.

12. The scanning recognition method based on a grouped straight-line grating according to claim 11, wherein light emitted or reflected by the objects to be detected is collected by the grouped straight-line grating and transmitted to the recognition device through optical fibers; the grouped straight-line grating is arranged on one end of each of the optical fibers, and the recognition device is arranged on the other end of each of the optical fibers.

13. The scanning recognition method based on a grouped straight-line grating according to claim 12, wherein one end of each of a plurality of optical fibers is arranged at intervals along the grating direction to form the light collecting points arranged in groups in straight lines at intervals, so as to form a multi-fiber straight-line grating or a multi-fiber staggered grating.

14. The scanning recognition method based on a grouped straight-line grating according to claim 12, wherein the end surface of one end of each single optical fiber is processed by photolithography, erosion or plating to form the light collecting points arranged in groups in straight lines at intervals, so as to form a single-fiber straight-line grating or a single-fiber staggered grating.

15. The scanning recognition method based on a grouped straight-line grating according to claim 3, wherein the direction of relative movement between the grouped straight-line grating and the detection plate is perpendicular to the grating direction.

16. The scanning recognition method based on a grouped straight-line grating according to claim 15, wherein light emitted or reflected by the objects to be detected is collected by the grouped straight-line grating and transmitted to the recognition device through optical fibers; the grouped straight-line grating is arranged on one end of each of the optical fibers, and the recognition device is arranged on the other end of each of the optical fibers.

17. The scanning recognition method based on a grouped straight-line grating according to claim 16, wherein one end of each of a plurality of optical fibers is arranged at intervals along the grating direction to form the light collecting points arranged in groups in straight lines at intervals, so as to form a multi-fiber straight-line grating or a multi-fiber staggered grating.

18. The scanning recognition method based on a grouped straight-line grating according to claim 16, wherein the end surface of one end of each single optical fiber is processed by photolithography, erosion or plating to form the light collecting points arranged in groups in straight lines at intervals, so as to form a single-fiber straight-line grating or a single-fiber staggered grating.

19. The scanning recognition method based on a grouped straight-line grating according to claim 4, wherein the direction of relative movement between the grouped straight-line grating and the detection plate is perpendicular to the grating direction.

20. The scanning recognition method based on a grouped straight-line grating according to claim 19, wherein light emitted or reflected by the objects to be detected is collected by the grouped straight-line grating and transmitted to the recognition device through optical fibers; the grouped straight-line grating is arranged on one end of each of the optical fibers, and the recognition device is arranged on the other end of each of the optical fibers.
